(19) United States
(12) Patent Application Publication
(10) Pub. No.: US 2026/0291150 A1
(43) Pub. Date: Sep. 24, 2026

(54) DONGLE

(71) Applicants: CHANNEL WELL TECHNOLOGY CO., LTD., Taoyuan City (TW); CYBENETICS LTD, Nicosia (CY); CHIA KWEI TECHNOLOGY (GUANG ZHOU)CO., LTD, GuangZhou (CN); CHANNEL WELL TECHNOLOGY (GUANGZHOU) CO., LTD., GuangZhou (CN); POWER PLUS TECHNOLOGY (WANZAI) CORP, Yichun City (CN); Ningbo Iso Electronic Co., Ltd, NINGBO (CN); Young Ling Enterprise Company Limited, Apia (WS); POWER PLUS TECHNOLOGY (VIETNAM) CORP, Que Vo Communc (VN); CHANNEL WELL TECHNOLOGY (VIETNAM) CO., LTD., Hanoi City (VN)

(72) Inventors: YEN-CHENG PAN, Taoyuan City (TW); CHIH-CHIANG HUANG, Taoyuan City (TW); Aristeidis Bitziopoulos, Nicosia (CY)

(73) Assignees: CHANNEL WELL TECHNOLOGY CO., LTD., Taoyuan City (TW); CYBENETICS LTD, Nicosia (CY); CHIA KWEI TECHNOLOGY (GUANG ZHOU)CO., LTD, GuangZhou (CN); CHANNEL WELL TECHNOLOGY (GUANGZHOU) CO., LTD., GuangZhou (CN); POWER PLUS TECHNOLOGY (WANZAI) CORP, Yichun City (CN); Ningbo Iso Electronic Co., Ltd, NINGBO (CN); Young Ling Enterprise Company Limited, Apia (WS); POWER PLUS TECHNOLOGY (VIETNAM) CORP, Que Vo Communc (VN); CHANNEL WELL TECHNOLOGY (VIETNAM) CO., LTD., Hanoi City (VN)

(21) Appl. No.: 19/339,368

(22) Filed: Sep. 25, 2025

(30) Foreign Application Priority Data
Mar. 18, 2025 (TW) 114110147

(51) Int. Cl. H01R 13/66; H01R 12/70; H01R 12/72; H01R 12/75; H01R 13/04; H01R 13/10; H01R 13/506

(52) U.S. Cl. CPC H01R 13/6683; H01R 12/7088; H01R 12/722; H01R 12/75; H01R 13/04; H01R 13/10; H01R 13/506; H01R 2201/06

(57) ABSTRACT

A dongle that connect an electronic device with a cable and has the function of protecting the electronic device, including: a first connector having a first arrangement direction and configured to detachably connect to the electronic device; a second connector having a second arrangement direction and configured to detachably connect to the cable, the second arrangement direction and the first arrangement direction include a specific angle, and the second connector is electrically connected to the first connector through a plurality of electrical paths; and a detection device is located between the first connector and the second connector, the detection device is configured to detect a working status all of the plurality of electrical paths between the first connector and the second connector, and when the working status is abnormal, disconnect one specific of the plurality of electrical paths, so that the electronic device stops working.

### CROSS-REFERENCE TO RELATED APPLICATION

This non-provisional application claims priority under 35 U.S.C. § 119 (a) on Patent Application No(s). 114110147 filed in Taiwan, R.O.C. on Mar. 18, 2025, the entire contents of which are hereby incorporated by reference.

### BACKGROUND OF THE INVENTION

### 1. Field of the Invention

The present disclosure relates to a dongle, and in particular, to a dongle having a function of protecting an electronic device.

### 2. Description of the Related Art

With the improvement of processing efficiency of a computer system, power consumption of electronic devices (such as processors and display cards) in the computer systems is increasing. For example, power consumption of a display card may reach 450 W to 600 W, or even a higher wattage. The display card usually needs an additional power supply, and a power supply unit provides, through a cable, a working power supply to the display card for use.

Generally, a motherboard and a power supply unit are arranged in a casing of a computer system. A display card is mounted on the motherboard, and a power supply unit is mounted below the display card. In order to output power of the power supply unit to the motherboard or the display card, the power supply unit and the motherboard are electrically connected through a cable, or the power supply unit and the display card are electrically connected through a cable.

### BRIEF SUMMARY OF THE INVENTION

However, based on recent use experience of display cards, a situation that a connector of a display card and a connector of the power supply unit both melt down occurs. A reason for the meltdown may be as follows: A cable between the power supply unit and the display card is excessively bent, causing a current to concentrate on some lines. Therefore, a temperature of the cable increases, which leads to meltdown, or in severe cases, may even lead to burning of the display card.

A dongle is used in a current connector design to alleviate excessive bending of a cable. Based on practical use experience of dongles, meltdown of the connector of the display card and the connector of the power supply unit declines. Nevertheless, a problem of dongle burning still occurs. Therefore, a current dongle lacks a function of protecting an electronic device based on a working status thereof.

In order to solve the foregoing problem, the present disclosure is intended to provide a dongle, which is connected to an electronic device and a cable and has a function of protecting the electronic device, including: a first connector, having a first arrangement direction and configured to detachably connect to the electronic device; a second connector, having a second arrangement direction and configured to detachably connect to the cable, the second arrangement direction and the first arrangement direction having a specific angle, and the second connector being electrically connected to the first connector through a plurality of electrical paths; and a monitoring device, located between the first connector and the second connector and configured to monitor a working status of all of the plurality of electrical paths, and cut off a specific one of the plurality of electrical paths when the working status is abnormal, so that the electronic device stops working.

In some embodiments, the dongle is arranged close to the electronic device.

In some embodiments, the specific angle is 90 degrees.

In some embodiments, the first connector is a 12VHPWR male connector, the second connector is a 12VHPWR female socket, and the specific electrical path is a path electrically connected to a pin between the 12VHPWR male connector and the 12VHPWR female socket defined as S0.

In some embodiments, the first connector is a 12VHPWR male connector, the second connector is a 12VHPWR female socket, and the specific electrical path is a path electrically connected to a pin between the 12VHPWR male connector and the 12VHPWR female socket defined as S1.

In some embodiments, a temperature monitoring circuit is further arranged on the monitoring device, and is configured to: monitor a working temperature of at least one of the plurality of electrical paths, and determine that the working status is abnormal and cut off the specific electrical path when the working temperature of the at least one electrical path is greater than a preset temperature value.

In some embodiments, a current monitoring circuit is further arranged on the monitoring device, and is configured to: monitor a working current of at least one of the plurality of electrical paths, and determine that the working status is abnormal and cut off the specific electrical path when the working current of the at least one electrical path is greater than a preset current value.

In some embodiments, a voltage monitoring circuit is further arranged on the monitoring device, and is configured to: monitor a working voltage of at least one of the plurality of electrical paths, and determine that the working status is abnormal and cut off the specific electrical path when the working voltage of the at least one electrical path is less than a preset voltage value.

In some embodiments, the monitoring device is arranged in a protective shell, and the protective shell includes: an upper cover, configured to partially cover the second connector; and a lower cover, configured to engage with the upper cover and then accommodate and protect the monitoring device.

In some embodiments, the monitoring device further includes a printed circuit board arranged between the first connector and the second connector.

Based on the above, according to the dongle of the present disclosure, it may be determined whether the plurality of electrical paths may be abnormal by monitoring the working status (for example, a working temperature, a working current, and/or a working voltage) of the plurality of electrical paths between the first connector and the second connector, and when it is determined that the working status is abnormal, the specific one of the plurality of electrical paths between the first connector and the second connector, so that the electronic device stops working, thereby achieving the function of protecting the electronic device in real time. In addition, although the electronic device stops working due to the protection function, the power supply unit for supplying power to the electronic device may still operate normally. Therefore, the computer system does not shut down after the electronic device stops working, and can remain some operating functions of the computer system, thereby improving use reliability of the computer system.

### BRIEF DESCRIPTION OF THE DRAWINGS

FIG. 1 is a schematic diagram of a dongle arranged between an electronic device and a cable according to an embodiment of the present disclosure.

FIG. 2 is a schematic outside diagram of the dongle according to an embodiment of the present disclosure.

FIG. 3 is a schematic diagram of an exploded structure of the dongle according to an embodiment of the present disclosure.

### DETAILED DESCRIPTION OF THE INVENTION

Specific structure or function descriptions in embodiments of the present disclosure described in this specification are provided only as examples for describing embodiments according to the concept of the present disclosure. The embodiments according to the concept of the present disclosure may be practiced in various forms and should not be construed as being limited to the embodiments described in the specification.

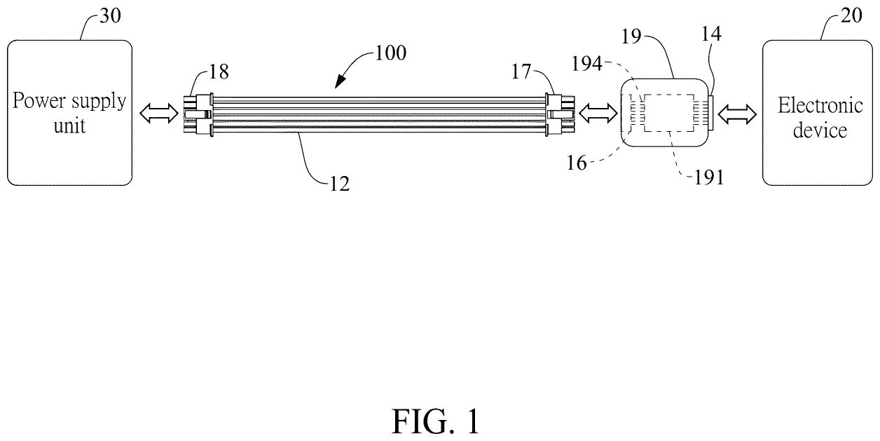

FIG. 1 is a schematic diagram of a dongle 19 arranged between an electronic device 20 and a cable 100 according to an embodiment of the present disclosure. The electronic device 20 and a power supply unit 30 may be electrically connected to each other through the cable 100.

Referring to FIG. 1, the dongle 19 may be configured to connect to the electronic device 20 and the cable 100. The dongle 19 has a function of protecting the electronic device 20. The electronic device 20 may be a display card or another electronic device, such as a motherboard, a compact disk drive, a solid state disk, or a redundant array of independent disks (RAID) device. In the embodiments of the present disclosure, a description is made by using an example that the electronic device 20 is a display card. In addition, the cable 100 may include a plurality of cables 12, a third connector 17, and a fourth connector 18.

The dongle 19 may include a first connector 14, a second connector 16, and a monitoring device 191.

A plurality of electrical paths 194 are arranged between the first connector 14 and the second connector 16. The second connector 16 is electrically connected to the first connector 14 through the plurality of electrical paths 194. In this embodiment, a number of the plurality of electrical paths 194 is 16, but is not limited thereto, and the number of the plurality of electrical paths 194 may alternatively be greater than 16 or less than 16.

The first connector 14 is configured to detachably connect to the electronic device 20. The first connector 14 may be composed of, for example, a 12VHPWR male connector. The first connector 14 in the dongle 19 has a first arrangement direction D1.

The second connector 16 is configured to detachably connect to the power supply unit 30. The second connector 16 may be composed of, for example, a 12VHPWR female socket. In another embodiment, the second connector 16 may be composed of, for example, two dual 8-pin female sockets. The second connector 16 in the dongle 19 has a second arrangement direction D2. The specific angle between the second arrangement direction D2 and the first arrangement direction D1 is 0.

In addition, the cable 100 in the embodiments of the present disclosure may be a cable that adopts a non-modular design, or may be a cable that adopts a modular design, and may be electrically connected to or detached from the electronic device and the dongle 19 quickly through the structures of the third connector 17 and the fourth connector 18.

The monitoring device 191 may have a printed circuit board 193. The monitoring device 191 may be located between the first connector 14 and the second connector 16, and is electrically connected to the plurality of electrical paths 194. The monitoring device 191 may be configured to: monitor a working status of all of the plurality of electrical paths 194, and cut off a specific one of the plurality of electrical paths 194 between the first connector 14 and the second connector 16 when the working status is abnormal, so that the electronic device 20 stops working.

For example, a current display card of the PCI-E 5.0 standard needs to be equipped with a 16-pin power supply connector (i.e., a 12VHPWR connector) to provide a maximum power supply wattage of 600 W.

Pin assignment of the foregoing 12VHPWR connector is shown in Table 1 below:

TABLE 1
Pin assignment of a 12VHPWR connector

| Pin position | Signal | Color |
|---|---|---|
| 1 | +12V3/V4 | Yellow |
| 2 | +12V3/V4 | Yellow |
| 3 | +12V3/V4 | Yellow |
| 4 | +12V3/V4 | Yellow |
| 5 | +12V3/V4 | Yellow |
| 6 | +12V3/V4 | Yellow |
| S1 | CARD_PWR_STABLE | Blue |
| S2 | CARD_CBL_PRES# | Blue |
| 7 | COM | Black |
| 8 | COM | Black |
| 9 | COM | Black |
| 10 | COM | Black |
| 11 | COM | Black |
| 12 | COM | Black |
| S3 | SENSE0 | Blue |
| S4 | SENSE1 | Blue |

When a pin S0 and a pin S1 of the 12VHPWR connector are grounded, the power supply unit 30 may provide a maximum power supply wattage of 600 W to the electronic device 20 through the cable 100 and the dongle 19 having the function of protecting the electronic device. In another embodiment, the power supply unit 30 may provide a power supply wattage higher than 600 W to the electronic device 20 through the cable 100 and the dongle 19 having the function of protecting the electronic device.

In this embodiment, two specific ones of the plurality of electrical paths 194 between the first connector 14 and the second connector 16 are cut off, so that the electronic device 20 stops working. For example, when the monitoring device 191 detects an abnormal working status of the plurality of electrical paths 194, a path of the plurality of electrical paths 194 between the first connector 14 and the second connector 16 defined as S0 may be cut off, or a path of the plurality of electrical paths 194 between the first connector 14 and the second connector 16 defined as S1 may be cut off, or paths of the plurality of electrical paths 194 between the first connector 14 and the second connector 16 defined as S0 and S1 may be cut off, so that the electronic device 20 stops working to achieve the function of protecting the electronic device 20. In addition, in another embodiment, three or more specific electrical paths of the plurality of electrical paths 194 between the first connector 14 and the second connector 16 may be cut off, so that the electronic device 20 stops working.

An operating principle of the foregoing function of protecting the electronic device 20 is based on the specification of the PCI-E 5.0 standard. When a pin of the 12VHPWR connector defined as S0 or S1 is open-circuited, the electronic device 20 stops working and enters a screen-off state, which indicates that the power supply unit 30 still supplies power, but the electronic device 20 does not work or consume power, so as to avoid a problem that the plurality of electrical paths 194 may burn down as a result of a high temperature caused by an excessively large working current or an excessively small working voltage, thereby achieving the function of protecting the electronic device 20.

It should be particularly noted that although the monitoring device 191 causes the electronic device 20 to stop working when detecting the abnormal working status of the plurality of electrical paths 194, the power supply unit 30 may still work normally and provide power to another device for use. Therefore, the computer system does not shut down after the electronic device 20 stops working, and can remain some operating functions of the computer system, thereby improving the use reliability of the computer system.

A monitoring mode and an operating mode of the monitoring device 191 are illustrated below.

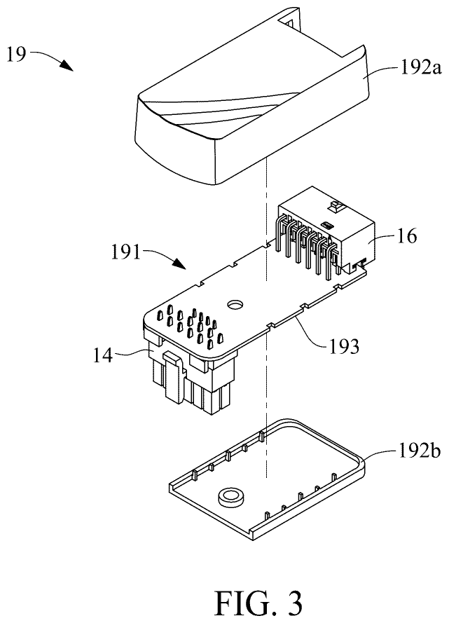

In some embodiments, the monitoring device 191 may include a printed circuit board 193 (shown in FIG. 3). The printed circuit board 193 in the monitoring device 191 may be provided with a temperature monitoring circuit. The temperature monitoring circuit may be composed of circuit elements such as a plurality of thermistors and one microcontroller. Each thermistor may correspondingly sense a temperature of each cable. The temperature monitoring circuit may be configured to monitor a working temperature of at least one of the plurality of electrical paths 194. When the working temperature of the at least one electrical path is greater than a preset temperature value, the microcontroller determines that the working status of the plurality of electrical paths 194 is abnormal, and cuts off a specific one (for example, the pin S0 or the pin S1) of the plurality of electrical paths 194 between the first connector 14 and the second connector 16, so that the electronic device 20 stops working. The preset temperature value may be a temperature value that may cause the plurality of electrical paths 194 to burn down at a high temperature obtained through experiments.

In some embodiments, the printed circuit board 193 in the monitoring device 191 may be provided with a current monitoring circuit. The current monitoring circuit may be composed of circuit elements such as a plurality of resistors, a plurality of comparators, and one microcontroller. The current monitoring circuit may be configured to monitor a working current of at least one of the plurality of electrical paths 194. When the working current of the at least one electrical path is greater than a preset current value, the microcontroller determines that the working status of the plurality of electrical paths 194 is abnormal, and cuts off a specific one (for example, the pin S0 or the pin S1) of the plurality of electrical paths 194 between the first connector 14 and the second connector 16, so that the electronic device 20 stops working. The preset current value may be a current value that may cause the plurality of electrical paths 194 to burn down at a high temperature obtained through experiments.

In some embodiments, the printed circuit board 193 in the monitoring device 191 may be provided with a voltage monitoring circuit. The voltage monitoring circuit may be composed of, for example, a plurality of resistors and one microcontroller. The voltage monitoring circuit may be configured to monitor a working voltage of at least one of the plurality of electrical paths 194. When the working voltage of the at least one electrical path is less than a preset voltage value, the microcontroller determines that the working status of the plurality of electrical paths 194 is abnormal, and cuts off a specific one (for example, the pin S0 or the pin S1) of the plurality of electrical paths 194 between the first connector 14 and the second connector 16, so that the electronic device 20 stops working. The preset voltage value may be a voltage value that may cause the plurality of electrical paths 194 to burn down at a high temperature obtained through experiments.

In some embodiments, the printed circuit board 193 in the monitoring device 191 may be provided with a temperature and current monitoring circuit. The temperature and current monitoring circuit may be composed of circuit elements such as a plurality of thermistors, a plurality of resistors, a plurality of comparators, and one microcontroller. The temperature and current monitoring circuit may be configured to monitor a working temperature and/or a working current of at least one of the plurality of electrical paths 194. When the working temperature of the at least one electrical path is greater than a preset temperature value, or when the working current of the at least one electrical path is greater than a preset current value, the microcontroller determines that the working status of the plurality of electrical paths 194 is abnormal, and cuts off a specific one (for example, the pin S0 or the pin S1) of the plurality of electrical paths 194 between the first connector 14 and the second connector 16, so that the electronic device 20 stops working. The preset temperature value or the preset current value may be a temperature value or a current value that may cause the plurality of electrical paths 194 to burn down at a high temperature obtained through experiments.

In some embodiments, the printed circuit board 193 in the monitoring device 191 may be provided with a temperature and voltage monitoring circuit. The temperature and voltage monitoring circuit may be composed of circuit elements such as a plurality of thermistors, a plurality of resistors, and one microcontroller. The temperature and voltage monitoring circuit may be configured to monitor a working temperature and/or a working voltage of at least one of the plurality of electrical paths 194. When the working temperature of the at least one electrical path is greater than a preset temperature value, or when the working voltage of the at least one electrical path is less than a preset voltage value, the microcontroller determines that the working status of the plurality of electrical paths 194 is abnormal, and cuts off a specific one (for example, the pin S0 or the pin S1) of the plurality of electrical paths 194 between the first connector 14 and the second connector 16, so that the electronic device 20 stops working. The preset temperature value or the preset voltage value may be a temperature value or a voltage value that may cause the plurality of electrical paths 194 to burn down at a high temperature obtained through experiments.

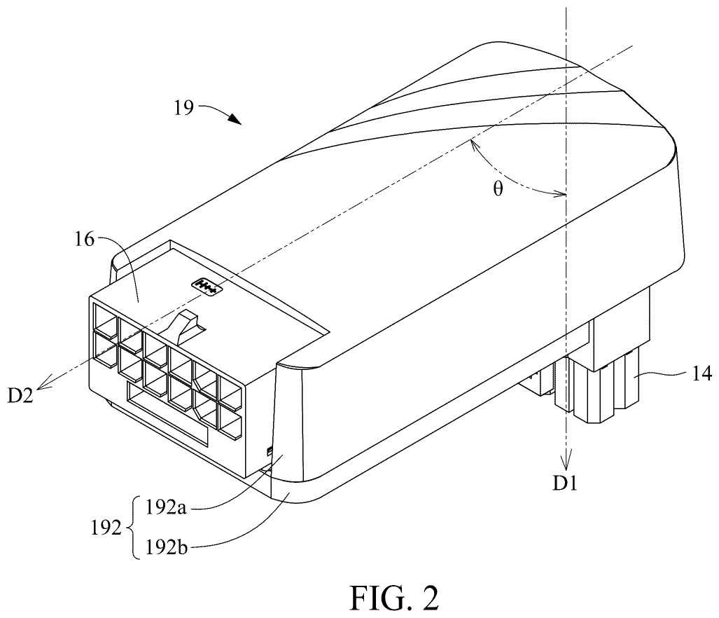

FIG. 2 is a schematic outside diagram of the dongle 19 according to an embodiment of the present disclosure.

Referring to FIG. 2, the monitoring device 191 may be arranged in a protective shell 192. The protective shell 192 includes an upper cover 192a and a lower cover 192b. The upper cover 192a is configured to partially cover the second connector 16. The lower cover 192b is configured to engage with the upper cover 192a and then accommodate and protect the monitoring device 191. The first connector 14 in the dongle 19 has a first arrangement direction D1. The second connector 16 in the dongle 19 has a second arrangement direction D2. The specific angle between the second arrangement direction D2 and the first arrangement direction D1 is 0. The specific angle θ may range from 80 degrees to 110 degrees, and preferably, may be 90 degrees.

The dongle 19 is configured to change a mounting direction between the third connector 17 of the cable 100 and a connector (not shown in the figure) of the electronic device 20. For example, the connector of the electronic device 20 and the third connector 17 of the cable 100 are originally located on the same horizontal line (i.e., on 180 degrees), and the 180 degrees may be changed to 90 degrees through the dongle 19, which can significantly alleviate a meltdown situation of the cable 100 between the power supply unit 30 and the electronic device 20 caused by temperature increase as a result of a current concentrating on some lines when the cable 100 is excessively bent. In addition, the dongle 19 may be made of a material such as plastic, rubber, or silica gel. The dongle 19 may be arranged between the electronic device and the third connector 17 and close to the electronic device 20. Because the arrangement position of the dongle 19 is close to the electronic device 20, and the foregoing arrangement position is a position where connector meltdown often occurs in the prior art, the dongle 19 can have a relatively good monitoring effect. In addition, based on the structural design of the dongle 19, after the second connector 16 is engaged with the third connector 17, a cable near the third connector 17 may extend smoothly without bending. Therefore, the dongle 19 can significantly reduce the situation that the cable 100 melts down as a result of temperature increase occurring when the cable is excessively bent. In another embodiment, the dongle 19 may be arranged between the power supply unit 30 and the fourth connector 18.

FIG. 3 is a schematic diagram of an exploded structure of the dongle 19 according to an embodiment of the present disclosure.

Referring to FIG. 3, the dongle 19 includes a first connector 14, a second connector 16, and a monitoring device 191. The upper cover 192a and the lower cover 192b may form a protective shell 192. The upper cover 192a and the lower cover 192b may be engaged with each other in a snap-fit manner, but is not limited thereto. In some embodiments, the upper cover 192a and the lower cover 192b may be engaged with each other in a bonding manner or in a screwing manner. The upper cover 192a is configured to partially cover the second connector 16. The lower cover 192b is configured to engage with the upper cover 192a and then accommodate and protect the monitoring device 191.

The printed circuit board 193 of the monitoring device 191 is arranged between the first connector 14 and the second connector 16. The plurality of electrical paths 194 may be arranged on an upper surface of the printed circuit board 193. In another embodiment, the plurality of electrical paths 194 may be arranged on a lower surface of the printed circuit board 193. In another embodiment, the plurality of electrical paths 194 may be arranged on the upper surface and the lower surface of the printed circuit board 193 respectively.

Based on the above, according to the dongle of the present disclosure, it may be determined whether the plurality of electrical paths may be abnormal by monitoring the working status (for example, a working temperature, a working current, and/or a working voltage) of the plurality of electrical paths between the first connector and the second connector, and when it is determined that the working status is abnormal, the specific one of the plurality of electrical paths between the first connector and the second connector, so that the electronic device stops working, thereby achieving the function of protecting the electronic device in real time. In addition, although the electronic device stops working due to the protection function, the power supply unit for supplying power to the electronic device may still operate normally. Therefore, the computer system does not shut down after the electronic device stops working, and can remain some operating functions of the computer system, thereby improving use reliability of the computer system.

The present invention is described by way of the preferred embodiments above. A person skilled in the art should understand that, these embodiments are merely for describing the present invention and are not to be construed as limitations to the scope of the present invention. It should be noted that all equivalent changes, replacements and substitutions made to the embodiments are to be encompassed within the scope of the present invention. Therefore, the scope of protection of the present invention should be accorded with the broadest interpretation of the appended claims.

What is claimed is:

1. A dongle, connected to an electronic device and a cable and having a function of protecting an electronic device, comprising:
a first connector, having a first arrangement direction and configured to detachably connect to the electronic device;
a second connector, having a second arrangement direction and configured to detachably connect to the cable, the second arrangement direction and the first arrangement direction having a specific angle, and the second connector being electrically connected to the first connector through a plurality of electrical paths; and
a monitoring device, located between the first connector and the second connector, electrically connected to the plurality of electrical paths, and configured to:
monitor a working status of all of the plurality of electrical paths between the first connector and the second connector, and cut off a specific one of the plurality of electrical paths when the working status is abnormal, so that the electronic device stops working.

2. The dongle according to claim 1, wherein the dongle is arranged close to the electronic device.

3. The dongle according to claim 1, wherein the specific angle is 90 degrees.

4. The dongle according to claim 2, wherein the specific angle is 90 degrees.

5. The dongle according to claim 1, wherein the first connector is a 12VHPWR male connector, the second connector is a 12VHPWR female socket, and the specific electrical path is a path electrically connected to a pin between the 12VHPWR male connector and the 12VHPWR female socket defined as S0.

6. The dongle according to claim 2, wherein the first connector is a 12VHPWR male connector, the second connector is a 12VHPWR female socket, and the specific electrical path is a path electrically connected to a pin between the 12VHPWR male connector and the 12VHPWR female socket defined as S0.

7. The dongle according to claim 1, wherein the first connector is a 12VHPWR male connector, the second connector is a 12VHPWR female socket, and the specific electrical path is a path electrically connected to a pin between the 12VHPWR male connector and the 12VHPWR female socket defined as S1.

8. The dongle according to claim 2, wherein the first connector is a 12VHPWR male connector, the second connector is a 12VHPWR female socket, and the specific electrical path is a path electrically connected to a pin between the 12VHPWR male connector and the 12VHPWR female socket defined as S1.

9. The dongle according to claim 1, wherein a temperature monitoring circuit is further arranged on the monitoring device, and is configured to: monitor a working temperature of at least one of the plurality of electrical paths, and determine that the working status is abnormal and cut off the specific electrical path when the working temperature of the at least one electrical path is greater than a preset temperature value.

10. The dongle according to claim 2, wherein a temperature monitoring circuit is further arranged on the monitoring device, and is configured to: monitor a working temperature of at least one of the plurality of electrical paths, and determine that the working status is abnormal and cut off the specific electrical path when the working temperature of the at least one electrical path is greater than a preset temperature value.

11. The dongle according to claim 1, wherein a current monitoring circuit is further arranged on the monitoring device, and is configured to: monitor a working current of at least one of the plurality of electrical paths, and determine that the working status is abnormal and cut off the specific electrical path when the working current of the at least one electrical path is greater than a preset current value.

12. The dongle according to claim 2, wherein a current monitoring circuit is further arranged on the monitoring device, and is configured to: monitor a working current of at least one of the plurality of electrical paths, and determine that the working status is abnormal and cut off the specific electrical path when the working current of the at least one electrical path is greater than a preset current value.

13. The dongle according to claim 1, wherein a voltage monitoring circuit is further arranged on the monitoring device, and is configured to: monitor a working voltage of at least one of the plurality of electrical paths, and determine that the working status is abnormal and cut off the specific electrical path when the working voltage of the at least one electrical path is less than a preset voltage value.

14. The dongle according to claim 2, wherein a voltage monitoring circuit is further arranged on the monitoring device, and is configured to: monitor a working voltage of at least one of the plurality of electrical paths, and determine that the working status is abnormal and cut off the specific electrical path when the working voltage of the at least one electrical path is less than a preset voltage value.

15. The dongle according to claim 1, wherein the monitoring device is arranged in a protective shell, and the protective shell comprises:
an upper cover, configured to partially cover the second connector; and
a lower cover, configured to engage with the upper cover and then accommodate and protect the monitoring device.

16. The dongle according to claim 2, wherein the monitoring device is arranged in a protective shell, and the protective shell comprises:
an upper cover, configured to partially cover the second connector; and
a lower cover, configured to engage with the upper cover and then accommodate and protect the monitoring device.

17. The dongle according to claim 1, wherein the monitoring device further comprises a printed circuit board arranged between the first connector and the second connector.

18. The dongle according to claim 2, wherein the monitoring device further comprises a printed circuit board arranged between the first connector and the second connector.
